(19) United States
(12) Patent Application Publication
(10) Pub. No.: US 2020/0332131 A1
(43) Pub. Date: Oct. 22, 2020

(54) FLAME RETARDANT AID, FLAME RETARDING AGENT COMPOSITION, AND METHOD FOR PRODUCING FLAME-RETARDANT FIBER FABRIC

(71) Applicant: NICCA CHEMICAL CO., LTD., Fukui-shi (JP)

(72) Inventor: Kimiyuki Suesada, Fukui-shi (JP)

(21) Appl. No.: 16/849,029

(22) Filed: Apr. 15, 2020

(30) Foreign Application Priority Data
Apr. 17, 2019 (JP) 2019-078590

(51) Int. Cl. C09D 5/18; C09D 133/02; C09D 139/02; C09D 147/00; C09K 21/12; D06N 3/00; D06N 3/04

(52) U.S. Cl. CPC C09D 5/18; C09D 133/02; C09D 139/02; C09D 147/00; C09K 21/12; D06N 2203/04; D06N 3/0059; D06N 3/04; D06N 2201/02; D06N 2209/067; D06N 3/0009

(57) ABSTRACT

A flame retardant aid includes an amphoteric polymer compound having at least one of a specific cationic unit such as allylamine, and an anionic unit such as maleic acid, and a flame retarding agent composition including the flame retardant aid. A method of producing a flame-retardant fiber fabric includes treating a polyester fiber fabric using a flame retardant aid including a flame retardant component and the above amphoteric polymer compound, and drying the polyester fiber fabric.

### FIELD

The present invention relates to a flame retardant aid, a flame retarding agent composition, and a method for producing a flame-retardant fiber fabric.

### BACKGROUND

Polyester fiber fabrics are widely used in vehicle interior materials, etc. These interior materials need to be flame retardant from the perspective of safety, and thus polyester fiber fabrics imparted with flame retardance are commonly used.

As a method for imparting fiber products such as polyester fiber fabrics with flame retardance, for example, backing processing using a flame retardant comprising a compound which has a high solubility in water such as ammonium polyphosphate is known (refer to, for example, PTL 1, etc.). However, in the case of using such a compound which has a high solubility in water in a flame retardant and then applying the compound to a fiber fabric, there is the problem known as water spotting in which, when the fiber fabric dries after absorbing water droplets or hot water, the compound dissolves due to the water content, moves towards the surface of the fiber fabric, and forms a circular spot when the area dries.

On the other hand, in order to suppress such water spotting, a method of padding processing in which a water dispersion of a compound which has a low water solubility is used in a flame retardant is known. For example, PTL 2 teaches a flame retarding method for polyester-based fiber products using a flame retarding agent comprising a water dispersion of aluminum trisdiethylphosphinate which has a low water solubility. However, in the case of using a compound which has a low water solubility in a flame retardant, there is the problem that the compound naturally has an extremely poor affinity for water such that the stability of the water dispersion is poor, and therefore the compound is difficult to use. In order to solve this problem, for example, emulsifying a flame retardant that has poor affinity for water with an emulsifier, etc., has been considered, but using such an emulsifier may invite water spotting and reduced fastness, and thus it is not preferable.

### CITATION LIST

### Patent Literature

[PTL 1] Japanese Unexamined Patent Publication (Kokai) No. 2007-204559
[PTL 2] Japanese Unexamined Patent Publication (Kokai) No. 2012-021247

### SUMMARY

### Technical Problem

As described above, achieving both improvement in flame retardance of a polyester fiber fabric and suppression of water spotting is generally difficult, and therefore there is a need in the art for a material and method which can suppress water spotting while improving flame retardance of the polyester fiber fabric.

Therefore, the present invention has the object of providing a flame retardant aid which can suppress water spotting while improving flame retardance of a polyester fiber fabric, a flame retarding agent composition comprising the same, and a method for producing a flame-retardant fiber fabric.

### Solution to Problem

The present invention, which achieves the above object, is as follows.

(1) A flame retardant aid, comprising an amphoteric polymer compound having at least one of a cationic unit selected from the group consisting of allylamine-based units expressed by the following structural formulas (I), (II) and (III):

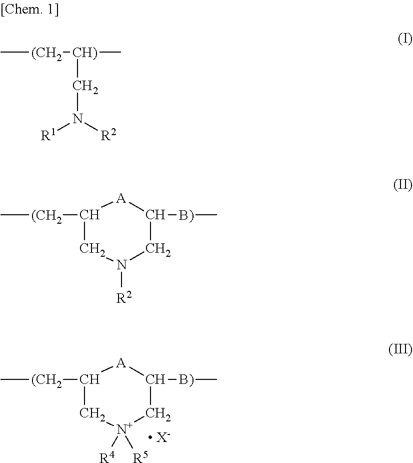

(where R¹ and R² are each independently a hydrogen atom, a methyl group, an ethyl group, or a cyclohexyl group, R³ is a hydrogen atom, a methyl group, an ethyl group, or a benzyl group, R⁴ and R⁵ are each independently a hydrogen atom, a methyl group, an ethyl group, or a benzyl group, A and B can be direct bonds or CH₂ (provided that when A is a direct bond, B is CH₂, and when A is CH₂, B is a direct bond), and X⁻ is an anion), and inorganic acid salts and organic acid salts thereof; and an anionic unit expressed by the following structural formula (IV):

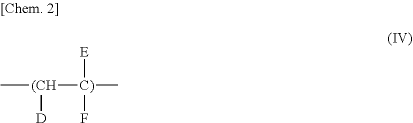

(where D is H or COOY, E is R⁶ or COOY, and F is H, COOY, or CH₂COOY (provided that when D is H, E is COOY and F is COOY or CH₂COOY and when D is COOY, E is R⁶ and F is COOY or E is COOY and F is H), R⁶ is a hydrogen atom or a methyl group, Y is each independently selected from the group consisting of a hydrogen atom, Na, K, NH₄, ½Ca, ½Mg, ½Fe, ⅓Al, and ⅓Fe).
(2) A flame retarding agent composition comprising a flame retardant component and the flame retardant aid according to the above (1).
(3) The flame retarding agent composition according to the above (2), wherein the flame retardant component comprises at least one selected from the group consisting of phosphoric acid, an acidic phosphate ester expressed by the following structural formula (A):

(RO)ₓ—P(═O)—(OH)₃₋ₓ (A)

(where R is a substituted or unsubstituted, linear, branched, or cyclic alkyl group having 1 to 10 carbon atoms, a substituted or unsubstituted, linear, branched, or cyclic alkenyl group having 2 to 10 carbon atoms, or a substituted or unsubstituted aryl group having 6 to 10 carbon atoms, and x is 1 or 2, wherein when x is 2, two R groups can be the same or different), and the salts thereof.

(4) The flame retarding agent composition according to the above (2) or (3), wherein the mass ratio of the amphoteric polymer compound to the flame retardant component is 0.5:10 to 5:10.
(5) A method for producing a flame-retardant fiber fabric, comprising treating a polyester fiber fabric using a flame retardant component and the flame retardant aid according to the above (1), and drying the polyester fiber fabric.

### Advantageous Effects of Invention

According to the present invention, by using a flame retardant aid comprising an amphoteric polymer compound having at least one of a cationic unit selected from the group consisting of allylamine-based units expressed by the above structural formulas (I), (II), and (III), and inorganic acid salts and organic acid salts thereof; and an anionic unit expressed by the above structural formula (IV) in conjunction with a flame retardant component, flame retardance of a polyester fiber fabric can be improved and water spotting can be prevented or remarkably suppressed. Additionally, according to the present invention, by using the flame retardant aid comprising the above amphoteric polymer compound, the generation of calcium salt compounds, which can be the cause of water spotting, via reactions of the flame retardant aid and the flame retardant component with calcium chloride, etc., can be remarkably suppressed. Furthermore, since the use of an emulsifier, etc., is not necessary and flame retardant components can be used in appropriate amounts, it is possible to achieve excellent fastness in the flame-retardant fiber fabric ultimately obtained.

### DESCRIPTION OF EMBODIMENTS

### <Flame Retardant Aid>

The flame retardant aid according an embodiment of the present invention comprises an amphoteric polymer compound having at least one of a cationic unit selected from the group consisting of allylamine-based units expressed by the following structural formulas (I), (II) and (III):

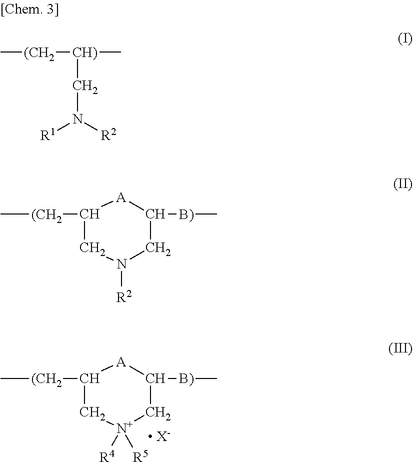

(where R¹ and R² are each independently a hydrogen atom, a methyl group, an ethyl group, or a cyclohexyl group, R³ is a hydrogen atom, a methyl group, an ethyl group, or a benzyl group, R⁴ and R⁵ are each independently a hydrogen atom, a methyl group, an ethyl group, or a benzyl group, A and B can be direct bonds or CH₂ (provided that when A is a direct bond, B is CH₂, and when A is CH₂, B is a direct bond), and X⁻ is an anion), and inorganic acid salts and organic acid salts thereof; and an anionic unit expressed by the following structural formula (IV):

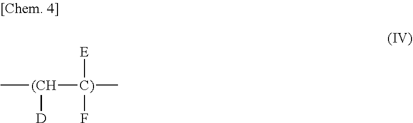

(where D is H or COOY, E is R⁶ or COOY, and F is H, COOY, or CH₂COOY (provided that when D is H, E is COOY and F is COOY or CH₂COOY and when D is COOY, E is R⁶ and F is COOY or E is COOY and F is H), R⁶ is a hydrogen atom or a methyl group, Y is each independently selected from the group consisting of a hydrogen atom, Na, K, NH₄, ½Ca, ½ Mg, ½Fe, ⅓Al, and ⅓Fe).

As stated above, in the case of using a compound which has a high solubility in water in a flame retardant when making fiber products, such as a polyester fiber fabric, flame retardant, there is the problem that water spotting, i.e., the phenomenon of forming circular spots when the fiber fabric to which the compound is applied absorbs water droplets or hot water and then dries, can occur. Also, in the case that an aqueous solution of calcium chloride, etc., is absorbed, calcium salt compounds which are not soluble in water can be generated, and can be the cause of water spotting. On the other hand, in the case of using a water dispersion of a compound with a low water solubility in a flame retardant in order to suppress water spotting, there is the problem that the stability of the water dispersion is poor, and the compound is difficult to use. Furthermore, emulsifying a flame retardant comprising a compound with a low water solubility using an emulsifier, etc., has been considered, but use of such an emulsifier may invite water spotting and reduced fastness. Additionally, even in the case of using a large amount of flame retardant to improve flame retardance, reduced fastness can occur.

Therefore, the present inventors examined not only flame retardant components used as the main material of a flame retardant, but also other components as a flame retardant aid. As a result, the present inventors found that by using a flame retardant aid comprising an amphoteric polymer compound having at least one of a cationic unit selected from the group consisting of allylamine-based units expressed by the above structural formulas (I), (II), and (III), and inorganic acid salts and organic acid salts thereof, and an anionic unit expressed by the above structural formula (IV), in conjunction with a flame retardant component, the flame retardance of a polyester fiber fabric could be improved while preventing or remarkably suppressing water spotting. Additionally, the present inventors found that by using a flame retardant aid comprising the above amphoteric polymer compound, the generation of calcium salt compounds, which can be the cause of water spotting, via reactions of the flame retardant aid and the flame retardant component with calcium chloride, etc., can be remarkably suppressed. Furthermore, the present inventors found that since use of an emulsifier, etc., is not necessary and flame retardant components can be used in appropriate amounts, it is possible to achieve excellent fastness in the flame-retardant fiber fabric ultimately obtained.

Without being bound by any particular theory, it is believed that the flame retardant aid comprising the above amphoteric polymer compound does not demonstrate any flame retardance or sufficient flame retardance on its own, but when used in conjunction with the flame retardant component, which is the main material, flame retardance can be improved due to the amine moiety contained in the cationic unit and the carboxylic acid moiety contained in the anionic unit in the amphoteric polymer compound. Further, it is believed that since the amphoteric polymer compound has a cationic unit and an anionic unit in appropriate amounts, it becomes a strong film when applied to the surface of a polyester fiber fabric, such that the water repellence of the polyester fiber fabric can be improved, and water spotting is prevented or suppressed due to this improvement in water repellence. As a result, according to the present invention, without limiting a combination with a specific flame retardant component, it is possible to improve the flame retardance of a polyester fiber fabric and prevent or remarkably suppress water spotting through a combination with any flame retardant component, for example, a flame retardant component comprised of not only phosphorous-based compounds, but nitrogen-based compounds, boron-based compounds, bromine-based compounds, and/or antimony-based compounds, etc. The amphoteric polymer compound according to an embodiment of the present invention will be described in detail below.

### [Amphoteric Polymer Compound]

As mentioned above, the amphoteric polymer compound according to an embodiment of the present invention has at least one of a cationic unit selected from the group consisting of monoallylamine-based units expressed by the following structural formula (I):

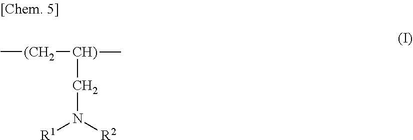

diallylamine-based units expressed by the following structural formulas (II) and (III):

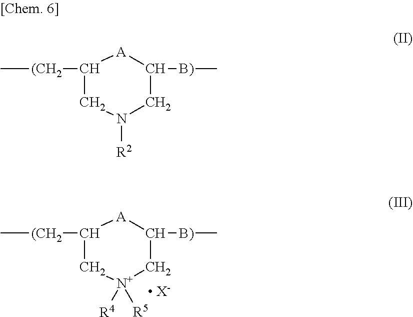

and inorganic acid salts and organic acid salts thereof, where R¹ and R² are each independently a hydrogen atom, a methyl group, an ethyl group, or a cyclohexyl group, and are preferably a hydrogen atom or a methyl group, R³ is a hydrogen atom, a methyl group, an ethyl group, or a benzyl group, and is preferably a hydrogen atom or a methyl group, R⁴ and R⁵ are each independently a hydrogen atom, a methyl group, an ethyl group, or a benzyl group, and are preferably a hydrogen atom or a methyl group, A and B can be direct bonds or CH₂ (provided that when A is a direct bond, B is CH₂, and when A is CH₂, B is a direct bond), preferably, A is a direct bond, B is CH₂, and X⁻ is an anion. X⁻ may be any appropriate anion and is not particularly limited, and can be selected from the group consisting of, for example, a chloride ion, bromide ion, iodide ion, alkyl sulfate ion, hydrogen sulfate ion, sulfamate ion, cyanide ion, and thiocyanate ion.

Additionally, the amphoteric polymer compound according to an embodiment of the present invention has an anionic unit expressed by the following structural formula (IV):

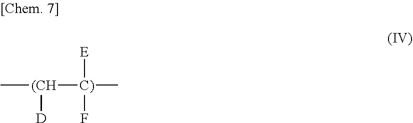

where D is H or COOY, E is R⁶ or COOY, and F is H, COOY, or CH₂COOY (provided that when D is H, E is COOY and F is COOY or CH₂COOY and when D is COOY, E is R⁶ and F is COOY or E is COOY and F is H, preferably when D is COOY, E is COOY and F is H), R⁶ is a hydrogen atom or a methyl group, and is preferably a hydrogen atom, Y is each independently selected from the group consisting of a hydrogen atom, Na, K, NH₄, ½Ca, ½ Mg, ½Fe, ⅓Al, and ⅓Fe, and is preferably a hydrogen atom.

By using an amphoteric polymer compound having at least one of the above cationic units and the above anionic unit as a flame retardant aid in conjunction with a flame retardant component, the flame retardance of the polyester fiber fabric obtained can be improved due to the amine portion contained in the cationic unit and the carboxylic acid portion contained in the anionic unit in the amphoteric polymer compound. Furthermore, by including the cationic unit and the anionic unit in appropriate amounts in the amphoteric polymer compound, a strong film can form on the surface of the polyester fiber fabric, and water repellence of the polyester fiber fabric can be increased, whereby it is possible to prevent or remarkably suppress water spotting in the polyester fiber fabric.

The flame retardant aid can be composed of only the above amphoteric polymer compound, or may comprise the above amphoteric polymer compound and any other flame retardant aid known to a person skilled in the art. The flame retardant aid comprising the amphoteric polymer compound is used in conjunction with the flame retardant component, but not necessarily used simultaneously with the flame retardant component. Therefore, when using the flame retardant aid comprising the amphoteric polymer compound, the flame retardant aid and the flame retardant component can be added in the same treatment bath or different treatment baths.

According to an embodiment of the present invention, the specific combination of at least one of the cationic units selected from the group consisting of allylamine-based units expressed by structural formulas (I), (II), and (III), and inorganic acid salts and organic acid salts thereof, and the anionic unit expressed by structural formula (IV) can be any combination, and can be a combination of the same type or different two or more types of cationic units with the same type or different two or more types of anionic units. The above combination is not particularly limited, for example, preferably be a combination of a cationic unit selected from the group consisting of allylamine-based units expressed by the structural formula (I) and structural formulas (II) and (III) in which A is a direct bond and B is CH₂, and inorganic acid salts and organic acid salts thereof, and an anionic unit expressed by structural formula (IV) in which D is H, E is COOY, and F is CH₂COOY, or D is COOY, E is COOY, and F is H.

The amphoteric polymer compound according to an embodiment of the present invention is commercially available or can be synthesized by co-polymerizing cationic monomers and anionic monomers. For example, the cationic monomer used when synthesizing by co-polymerization can include monoallylamines or diallylamines, specific examples of which are as follows.

### (1) Monoallylamines

The monoallylamines include monoallylamine, N-methylallylamine, N-ethylallylamine, N,N-dimethylallylamine, N,N-diethylallylamine, N-cyclohexylallylamine, N-methyl, N-cyclohexylallylamine, N-ethyl,N-cyclohexylallylamine, and N,N-dicyclohexylallylamine, etc.

### (2) Diallylamines

The diallylamines include diallylamine, N-methyldiallylamine, N-ethyldiallylamine, N-benzyldiallylamine, diallyldimethylammonium chloride, diallyldimethylammonium bromide, diallyldimethylammonium iodide, diallyldimethylammonium methylsulfate, diallyldiethylammonium chloride, diallyldiethylammonium bromide, diallyldiethylammonium iodide, diallyldiethylammonium methylsulfate, diallylmethylbenzylammonium chloride, diallylmethylbenzylammonium bromide, diallylmethylbenzylammonium iodide, diallylmethylbenzylammonium methylsulfate, diallylethylbenzylammonium chloride, diallylethylbenzylammonium bromide, diallylethylbenzylammonium iodide, diallylethylbenzylammonium methylsulfate, diallyldibenzylammonium chloride, diallyldibenzylammonium bromide, diallyldibenzylammonium iodide, and diallyldibenzylammonium methylsulfate, etc.

In the above monoallylamines and diallylamines, the inorganic acid salts of each, such as chloride salts, sulfate salts, nitrate salts, or phosphate salts, or the organic acid salts of each, such as acetate salts, etc., can be the starting monomer for co-polymerization. Alternately, instead of using these salts as starting monomers, the above acidic components (inorganic acid or organic acid) can be added after co-polymerization with the following anionic monomer, and mixed, thereby introducing the acidic components into the copolymer.

Specific examples of the anionic monomer which copolymerizes with the cationic monomer are not particularly limited, and include maleic acid, fumaric acid, citraconic acid, and itaconic acid, as well as the sodium, potassium, and ammonium salts thereof, etc.

In a specific embodiment of the present invention, the amphoteric polymer compound is synthesized by the co-polymerization of at least one of monoallylamine, diallylamine, N-methyldiallylamine, N-benzyldiallylamine, diallylmethylammonium chloride, and diallyldimethylammonium chloride as the above cationic monomer, and at least one of maleic acid, fumaric acid, itaconic acid and citraconic acid as the anionic monomer, wherein in this copolymer, the copolymer molar ratio of cationic unit/anionic unit is preferably 5/1 to ⅓, more preferably 3/1 to ½. The molecular weight of this copolymer is generally 1,000 to 500,000, and is preferably 1,000 to 200,000. Since the molecular weight of this amphoteric polymer compound is relatively small, the viscosity does not become excessively high even in aqueous solutions, which is preferable from the perspective of handling.

For example, when synthesizing the amphoteric polymer compound, first, the cationic monomer and the anionic monomer are mixed in water. In this case, the molar ratio of cationic monomer/anionic monomer is, as described above, preferably 5/1 to ⅓, more preferably 3/1 to ½. If the molar ratio exceeds 5/1 or is less than ⅓, the polymerization yield of the co-polymerization reaction may decrease significantly. The monomer concentration in the water in the case of copolymerization can change depending on the type of monomer, but is generally from 10 to 75%.

The copolymerization reaction is a radical polymerization reaction, and is thus performed in the presence of a radical polymerization catalyst. The radical polymerization catalyst is not particularly limited, and can include a peroxide such as t-butyl hydroperoxide, a persulfate such as ammonium persulfate, sodium persulfate and potassium persulfate, and a water-soluble azo compound such as azobis-based and diazo-based compounds. The amount added of the radical polymerization catalyst is generally 1 to 5 mol %, preferably 1 to 3 mol %, relative to the monomer. The polymerization temperature is generally 20 to 100° C., preferably 35 to 75° C. The polymerization time is generally 20 to 150 hours, preferably 30 to 100 hours. The polymerization atmosphere is not particularly limited, and can be air or a nitrogen atmosphere, etc.

### <Flame Retarding Agent Composition>

According to another embodiment of the present invention, the flame retardant aid comprising the above amphoteric polymer compound can be used in combination with a flame retardant component as a flame retarding agent composition. By using this flame retarding agent composition, the flame retardance of a fiber fabric obtained from a flame retardant component can be further improved by a flame retardant aid comprising the amphoteric polymer compound, and water spotting can be prevented or remarkably suppressed.

### [Flame Retardant Component]

The flame retardant component can be any flame retardant component known to a person skilled in the art, is not particularly limited, and can comprise at least one selected from the group consisting of phosphoric acid, an acidic phosphate ester expressed by the following structural formula (A):

(RO)ₓ—P(═O)—(OH)₃₋ₓ (A)

where R is a substituted or unsubstituted, linear, branched, or cyclic alkyl group having 1 to 10 carbon atoms, preferably 1 to 4 carbon atoms, a substituted or unsubstituted, linear, branched, or cyclic alkenyl group having 2 to 10 carbon atoms, preferably 2 to 4 carbon atoms, or a substituted or unsubstituted aryl group having 6 to 10 carbon atoms, and x is 1 or 2, wherein when x is 2, two R groups can be the same or different; and salts thereof, and in particular, can be at least one selected from the above options.

The salts of phosphoric acid and the acidic phosphate ester expressed by structural formula (A) are not particularly limited, and include, for example, alkali metal salts such as sodium, potassium, and lithium salts;

alkaline earth metal salts such as magnesium, calcium, and barium salts;

other metal salts such as zinc, aluminum, and zirconium salts;

alkylamine salts such as monomethylamine, dimethylamine, trimethylamine, monoethylamine, diethylamine, and triethylamine salts;

alkanolamine salts such as monoethanolamine, diethanolamine, triethanolamine, monoisopropanolamine, diisopropanolamine, triisopropanolamine, monomethylethanolamine, dimethylethanolamine, monoethylethanolamine, diethylethanolamine, and tris(hydroxymethyl)aminomethane salts;

polyamine salts such as salts of ethylenediamine, diethylenetriamine, polyethyleneimine, dicyandiamide, condensates of dicyandiamide, condensates of dicyandiamide and polyalkylenepolyamine, condensates of dicyandiamide, polyalkylenepolyamine and urea, and condensates of dicyandiamide and formaldehyde;

quaternary ammonium salts such as tetramethylammonium, tetraethylammonium, tetramethanolammonium, and tetraethanolammonium salts; and

melamine salts, guanylurea salts, and guanidine salts, etc.

Of the phosphoric acid and the acidic phosphate ester expressed by structural formula (A), from the perspective of flame retardance, phosphoric acid is preferable. Of the acidic phosphate esters, esters with fewer carbon atoms is preferable. Additionally, of the flame retardant components listed above, from the perspective of flame retardance, salts of phosphoric acid and acidic phosphate ester expressed by structural formula (A) are preferable, and of those salts, alkylamine salt, alkanolamine salt, polyamine salt, quaternary ammonium salt, melamine salt, guanylurea salt, and guanidine salt are preferable, alkylamine salt, alkanolamine salt, polyamine salt, quaternary ammonium salt, and guanidine salt are more preferable, and guanidine salt is most preferable.

In the flame retarding agent composition according to an embodiment of the present invention, the mass ratio of amphoteric polymer compound to flame retardant component is not particularly limited and can be any appropriate mass ratio. However, if the amount of amphoteric polymer compound is too low, the flame retardance improvement effect and the water spotting suppression effect may not be sufficiently obtained in some cases, whereas if the amount of amphoteric polymer compound is too high, these effect can become saturated, or since the amount of flame retardant component, which is the main material, is relatively less, sufficient flame retardance may not be obtained, and in addition, water spotting may be encouraged enough to occur in some cases. Therefore, the mass ratio of amphoteric polymer compound to flame retardant compound is generally 0.3:10 to 7:10, preferably 0.5:10 to 5:10, more preferably 1:10 to 3:10.

The flame retarding agent composition according to an embodiment of the present invention is not particularly limited, and generally has a pH of 3.0 to 7.0. Additionally, the flame retarding agent composition can comprise any substances in addition to those above as long as the effect of the present invention is not diminished. The substances are not particularly limited, but include, for example, an organic solvent, pH adjuster, chelating agent, potential adjuster, surfactant (anionic surfactant, nonionic surfactant, cationic surfactant, amphoteric surfactant, etc.), preservative, defoamer, and anti-tarnish agent, etc. The amount of these substances is not particularly limited, and can be appropriately determined within a range in which imperfections do not occur during manufacture and storage by considering performance and processing stability.

The organic solvent is not particularly limited and can be any appropriate organic solvent, but from the perspective of improving the storage stability and/or handleability of the flame retarding agent composition, the organic solvent can include, for example, methanol, ethanol, isopropanol, ethylene glycol monobutyl ether, ethylene glycol, propylene glycol, dipropylene glycol monomethyl ether, hexylene glycol, benzyl alcohol, and 3-methoxy-3-methyl-1-butanol (Solfit), etc.

The pH adjuster can be any appropriate alkali or acid. Examples of the alkali can include hydroxides such as sodium hydroxide and potassium hydroxide; carbonates such as sodium carbonate, sodium bicarbonate, potassium carbonate and sodium sesquicarbonate; borates such as potassium borate and sodium borate; hydrogen sulfates such as sodium hydrogen sulfate and potassium hydrogen sulfate; inorganic alkali metal salts such as sodium silicate, sodium metasilicate, potassium silicate, potassium metasilicate, and zeolite; organic alkali metal salts such as sodium formate, sodium acetate, and sodium oxalate; organic amines such as monoethanolamine, diethanolamine, triethanolamine and triethylamine; and ammonia, etc. Of these, hydroxides such as sodium hydroxide and potassium hydroxide are preferable. Examples of the acid can include organic acids such as lactic acid, acetic acid, propionic acid, maleic acid, oxalic acid, formic acid, methanesulfonic acid and toluenesulfonic acid; and inorganic acids such as hydrogen chloride, sulfuric acid and nitric acid. These pH adjusters can be used alone or in combination of two or more.

Examples of the chelating agent can include EDTA (ethylenediaminetetraacetic acid), HEDTA (hydroxyethylethylenediaminetriacetic acid), DTPA (diethylenetriaminepentaacetic acid) and salts thereof; phosphonic acids such as phytic acid and etidronic acid and salts such as sodium salts thereof; organic acids such as oxalic acid, citric acid, alanine, dihydroxyethylglycine, gluconic acid, ascorbic acid, succinic acid, tartaric acid, glutaric acid, malonic acid and salts thereof; polyamino acids such as polyaspartic acid, and polyglutamic acid; and polycarboxylic acids, polymaleic acids and their salts, etc. Of these, from the perspective of effect on the environment, organic acids such as sodium citrate or salts thereof are preferable.

The flame retarding agent composition according to an embodiment of the present invention can optionally further comprise a finishing agent. The finishing agent is not particularly limited, and includes, for example, a ground thread breakage preventing agent (SUNMARINA TS-155GT, etc.), a hydrophilic agent that imparts water absorption, moisture absorption, and antistatic properties, etc. (processing agents comprising polyethylene glycol derivatives and various hydrophilic polymers, etc.), a water/oil repellent (higher aliphatic compound, silicone-based, fluorine-based, etc.), a fungicide (phenolic-based, etc.), a softener (silicone-based, anionic, cationic, etc.), an anti-fusing agent (silicone-based, polyamide-based, etc.), or a hard finish agent (melamine-based, urethane-based, etc.) and the like.

The flame retarding agent composition according to an embodiment of the present invention is particularly useful for imparting flame retardance to, for example, the interior fabric for vehicles such as automobiles, and can be suitably used in any other application in which improvement of flame retardance and prevention or suppression of water spotting must both be achieved, for example, an application such as clothing or interiors.

### <Method for Producing Flame-Retardant Fiber Fabric>

In the present invention, a method for producing a flame-retardant fiber fabric is further provided. The method is characterized by comprising treating a polyester fiber fabric using a flame retardant component and a flame retardant aid comprising the amphoteric polymer compound described above, and drying the polyester fiber fabric.

### [Treatment Step]

In the treatment step, the polyester fiber fabric is treated using a flame retardant component and a flame retardant aid comprising an amphoteric polymer compound. More specifically, the flame retardant component and the flame retardant aid can be imparted to the polyester fiber fabric by a padding process comprising immersing a polyester fiber fabric in a treatment solution containing the flame retardant component and/or the flame retardant aid or a spraying process comprising spraying the polyester fiber fabric with the treatment solution using a spray nozzle, etc.

The flame retardant component used in this treatment step can be any flame retardant component known to a person skilled in the art, is not particularly limited, and can be, for example, a flame retardant component comprising at least one selected from the group consisting of phosphoric acid, an acidic phosphate ester expressed by the structural formula (A) described above, and salts thereof.

The polyester fiber fabric used in the treatment step is not particularly limited, and can be a fabric comprised of polyester fibers comprising, for example, regular polyester fibers, cationic dyeable polyester fibers, recycled polyester fibers, or two or more of the above. Additionally, the polyester fiber fabric can be a composite fiber fabric obtained by blending the above polyester fibers with natural fibers such as cotton, hemp, silk, or wool fibers; semi-synthetic fibers such as rayon or acetate fibers; synthetic fibers such as nylon, acrylic, or polyamide fibers; inorganic fibers such as carbon fibers, glass fibers, ceramic fibers, or metal fibers; synthetic leather of urethane; or fibers comprising two or more types thereof.

The form of the polyester fiber fabric can include tricot such as brushed and velor, double raschel such as high veil brushed, circular knitting such as sinker pile, knitting such as jersey, woven fabric such as jaguar moquette, and non-woven fabric such as needle punch, stitch pound, or spunlace. Of these forms, tricot and jersey knitting are suitably used. The thickness and the basis weight of the polyester fiber fabric are not particularly limited, and can be appropriately selected in accordance with the material. For example, the polyester fiber fabric thickness can be around 0.1 to 5 mm and the basis weight can be around 10 to 350 g/m².

In the present treatment step, the flame retardant aid comprising the amphoteric polymer compound is used in conjunction with the flame retardant component, but does not necessarily need to be used simultaneously with the flame retardant component. In other words, it is possible to perform treatment in one bath by using the flame retarding agent composition comprising both the flame retardant component and the flame retardant aid described above without any modification as a treatment solution; or using a treatment solution obtained by diluting the flame retarding agent composition with at least one of water and an aqueous medium, it is possible to perform treatment in one bath by simultaneously or sequentially adding the flame retardant component and the flame retardant aid, or it is possible to perform treatment in two baths by using a treatment solution comprising the flame retardant component and a separate treatment solution comprising the flame retardant aid. In the case of performing treatment using two baths, either of the treatment solution comprising the flame retardant component and the separate treatment solution comprising the flame retardant aid can be used first to perform the treatment.

The above aqueous medium is preferably a hydrophilic solvent miscible in water. The hydrophilic solvent includes, for example, methanol, ethanol, isopropyl alcohol, ethylene glycol, propylene glycol, diethylene glycol, hexylene glycol, glycerin, butyl glycol, butyl diglycol, 3-methoxy-3-methyl-1-butanol (Solfit), N-methylpyrrolidone, dimethylformamide, and dimethylsulfo oxide, etc.

In the case of treating by a padding process, the polyester fiber fabric is soaked in one or two baths using a treatment solution comprising the flame retardant component and/or the flame retardant aid, and then squeezed with a roller such that a predetermined water content is reached, while making the flame retardant component and the flame retardant aid soak into the polyester fiber fabric. The soaking time and squeeze rate can be appropriately selected in accordance with the thickness and basis weight of the polyester fiber fabric to be treated and with the predetermined amount of flame retardant component applied, are not particularly limited, and can be, for example, a soaking time of 1 to 5 seconds and a squeeze rate of 50 to 100%.

On the other hand, in the case of treating by a spraying process, the flame retardant component and the flame retardant aid can be sprayed on the polyester fiber fabric using a treatment solution containing the flame retardant component and/or the flame retardant aid while continuously transferring the polyester fiber fabric via a conveyor, etc. The detailed conditions for the spraying process can be appropriately selected in accordance with the thickness and basis weight of the polyester fiber fabric to be treated and with the predetermined amount of flame retardant component applied.

### [Drying Step]

The polyester fiber fabric treated by a padding process or a spraying process, etc., using the flame retardant component and the flame retardant aid is dried in the subsequent drying step, whereby the flame retardant component and the flame retardant aid become attached within the polyester fiber fabric. This drying is not particularly limited, and can be performed under conditions and with an appropriate method which are known to a person skilled in the art, such as natural drying and heat drying. For example, the drying can be performed for 30 seconds to 3 minutes at 100 to 180° C. using a heat treating device such as a pin stenter.

In addition to the above steps, various known processes can be performed before or after the flame retarding with the flame retardant component and the flame retardant aid. For example, dyeing, heat setting, and any type of finishing process (gluing, glazing, etc.) can be performed.

Regarding the amount of the flame retardant component and the flame retardant aid attached to the flame-retardant fiber fabric ultimately obtained, relative to 100 parts by mass of polyester fiber fabric, the sum of the flame retardant component and the amphoteric polymer compound is preferably 1 to 20 parts by mass, more preferably 3 to 10 parts by mass. By attaching the flame retardant component and the amphoteric polymer compound within this range, sufficient flame retardance can be imparted to the polyester fiber fabric, water spotting can be completely or sufficiently suppressed, which is preferable from the perspective of cost.

The flame-retardant fiber fabric produced by the method according to an embodiment of the present invention is particularly useful as, for example, the interior fabric for vehicles such as automobiles, but can also be suitably used in any other application where both improvement in flame retardance and prevention or suppression of water spotting are required, for example, an application such as clothing or interiors.

The present invention will be explained in detail by way of the Examples below, but the present invention is not limited thereto.

### EXAMPLES

In the present Examples, flame-retardant fiber fabrics comprising a polyester fiber fabric imparted with a flame retardant component and a flame retardant aid comprising an amphoteric polymer compound were produced and the properties thereof were investigated.

### [Dyeing Process of Polyester Fiber Fabric (Regular Polyester Jersey Knitting)]

First, a dyeing process was performed on a polyester fiber fabric imparted with a flame retardant component and a flame retardant aid. Specifically, water, and a disperse dye, a dispersion leveling agent and a pH adjuster indicated in Table 1 below were added into a pot of a mini color dyeing machine (Texam Co., Ltd.), and mixed until homogeneous to prepare a dyeing bath. Then, the regular polyester jersey knitting (basis weight: 250 g/m²) as the polyester fiber fabric was placed into the dyeing bath such that the bath ratio was 1:10, the dyeing bath was heated from 40° C. to 80° C. at 2° C./min, then from 80° C. to 130° C. at 1° C./min, and thereafter held at 130° C. for 30 minutes to perform the dyeing. Next, the dyeing bath was cooled to 80° C., the regular polyester jersey knitting was removed from the pot, reduction cleaning (80° C.×15 minutes, bath ratio=1:10) was performed using a treatment solution indicated in Table 2 below, and then water washing dehydration drying was performed to obtain a dyed fabric of polyester fibers.

TABLE 1

| Component | Details | Content |
|---|---|---|
| Disperse dye | Kayalon Polyester Black ECX-300 | 5% o.w.f |
| Dispersion leveling | NICCA SUNSOLT RM-3406 | 0.5 g/L |
| agent | | |
| pH adjuster | 90% acetic acid | 0.3 g/L |

TABLE 2

| Component | Details | Content |
|---|---|---|
| Soaping agent | SUNMORL RC-700E | 1 g/L |
| | CONC (Nicca | |
| | Chemical Co., Ltd.) | |
| Alkali agent | Soda ash | 2 g/L |
| Reducing agent | Sodium hydrosulfite | 2 g/L |

### [Production of Flame-Retardant Fiber Fabric]

Next, the dyed fabric of polyester fiber obtained above was treated using the flame retardant component and the flame retardant aid comprising the amphoteric polymer compound, and then dried to produce the flame-retardant fiber fabric. The flame retardant components used in the following Examples are as follows.

### (Flame Retardant Component 1)

Guanidine phosphate (Sanwa Chemical Co., Ltd.) was dissolved in water to have a nonvolatile portion of 50 mass %.

### (Flame Retardant Component 2)

119 g of Phoslex A-1: CH₃O—P(═O)—(OH)₂+(CH₃O)₂—P(═O)—OH (SC Organic Chemical Co., Ltd.) and 180 g of guanidine carbonate were mixed and adjusted with water to have a nonvolatile portion of 50 mass %.

### (Flame Retardant Component 3)

139 g of Phoslex A-2: C₂H₅O—P(═O)—(OH)₂+(C₂H₅₀)₂—P(═O)—OH (SC Organic Chemical Co., Ltd.) and 180 g of guanidine carbonate were mixed and adjusted with water to have a nonvolatile portion of 50 mass %.

### (Flame Retardant Component 4)

182 g of Phoslex A-4: C₄H₉O—P(═O)—(OH)₂+(C₄H₉O)₂—P(═O)—OH (SC Organic Chemical Co., Ltd.) and 180 g of guanidine carbonate were mixed and adjusted with water to have a nonvolatile portion of 50 mass %.

### Example 1

First, 5 g of an amphoteric polymer compound (solid content 20%) consisting of a copolymer of allylamine and maleic acid as a flame retardant aid, 10 g of the flame retardant component 1, and 1.5 g of SUNMARINA TS-155GT (Nicca Co., Ltd., ground thread breakage preventing agent) as an optional finishing agent were diluted with water to obtain 100 g of a treatment solution (pH 5.0). Then, the treatment solution was used to perform a padding process on the dyed fabric of polyester fiber obtained above with a squeeze rate of 70%. Next, padding processed dyed fabric of polyester fiber was dried at 110° C. for 2 minutes and then at 170° C. for 30 seconds using a pin stenter, whereby a flame-retardant fiber fabric having attached thereto an amphoteric polymer compound and a flame retardant component (mass ration 2:10) was produced. The total amount of flame retardant component and flame retardant aid attached was 4.2 parts by mass relative to 100 parts by mass of polyester fiber fabric.

### Example 2

Except for using 2.5 g of an amphoteric polymer compound (solid content 40%) consisting of a copolymer of diallylamine hydrochloride and maleic acid as a flame retardant aid, a flame-retardant fiber fabric having attached thereto an amphoteric polymer compound and a flame retardant component (mass ratio 2:10) was produced in the same manner as in Example 1.

### Example 3

Except for using 5 g of an amphoteric polymer compound (solid content 20%) consisting of a copolymer of methyl diallylamine and maleic acid as a flame retardant aid, a flame-retardant fiber fabric having attached thereto an amphoteric polymer compound and a flame retardant component (mass ratio 2:10) was produced in the same manner as in Example 1.

### Example 4

Except for using 3.3 g of an amphoteric polymer compound (solid content 30%) consisting of a copolymer (molecular weight 25,000) of diallyldimethylammonium chloride and maleic acid as the flame retardant aid, a flame-retardant fiber fabric having attached thereto an amphoteric polymer compound and a flame retardant component (mass ratio 2:10) was produced in the same manner as in Example 1.

### Examples 5 to 7

Except for using the flame retardant components 2 to 4 in Examples 5 to 7, respectively, the flame-retardant fiber fabrics of Examples 5 to 7 having attached thereto an amphoteric polymer compound and a flame retardant component (mass ratio 2:10) were produced in the same manner as in Example 4.

### Examples 8 and 9

Except for altering the mass ratios of amphoteric polymer compound and flame retardant component of Examples 8 and 9 to 0.5:10 and 5:10, respectively, the flame-retardant fiber fabrics of Examples 8 and 9 were produced in the same manner as in Example 1.

### Comparative Examples 1 to 4

Except for using 12 g of flame retardant components 1 to 4 in Comparative Examples 1 to 4, respectively, and not using a flame retardant aid, the flame-retardant fiber fabrics of Comparative Examples 1 to 4 were produced in the same manner as in Example 1.

### Comparative Example 5

Except for using 20 g of an amphoteric polymer compound (solid content 30%) consisting of a copolymer (molecular weight 25,000) of diallyldimethylammonium chloride and maleic acid as a flame retardant aid, and not using a flame retardant component, a flame-retardant fiber fabric was produced in the same manner as in Example 1.

The flame-retardant fiber fabrics of Examples 1 to 9 and Comparative Examples 1 to 5 were evaluated according to the following methods in terms of flame retardance, water spotting prevention, calcium chloride reactivity (CaCl₂) reactivity), and fastness.

### [Evaluation of Flame Retardance]

Flame retardance was evaluated according the following criteria upon measuring the burn distance, burn time, and burn rate of the flame-retardant fiber fabric in accordance with FMVSS (Federal Motor Vehicle Safety Standards) No. 302 Combustion test standards of vehicle interior materials. In the evaluation, NB, SE, and SNBR were considered “Pass” and B was considered “Fail.”

TABLE 3

| Evaluation | Criteria | Pass/Fail |
|---|---|---|
| NB: Incombustibility | Burn distance 0 mm or less | Pass |
| SE: Self-extinguishing | Burn distance 50 mm or less | Pass |
| | and burn time less than 60 | |
| | seconds | |
| SNBR: Slow-burning | Burn rate 80 mm/minute or less | Pass |
| B: Flammability | Burn rate more than 80 mm/minute | Fail |

### [Evaluation of Water Spotting Prevention]

Water spotting prevention was evaluated by dripping 4 mL of 90° C. distilled water (hot water) on a flame-retardant fiber fabric, which was blown dried at room temperature, and then visually observing the presence or absence of water spotting on the surface of the flame-retardant fiber fabric. If water spotting was not found, the evaluation was a “Pass” (P), and if water spotting was found, it was a “Fail” (F).

[Evaluation of Reactivity with Calcium Chloride (CaCl₂))]

Calcium chloride (CaCl₂)) reactivity was evaluated by mixing 100 g of a treatment solution from each of the Examples and Comparative Examples with 100 g of a 10 mass % aqueous calcium chloride solution, leaving the mixture to sit for 1 day, and then visually observing the appearance. If white precipitate was not found, the evaluation was a “Pass” (P), and if white precipitate was found, it was a “Fail” (F).

### [Fastness]

Fastness was evaluated by performing friction fastness tests (wetting test) in accordance with the method of JIS L0849:2013 Friction testing machine Type-II (Learning form). The larger the number of the evaluation, the higher the fastness. Fastness was judged “Good” if the number was three or higher.

The obtained results are shown in Table 4 below.

TABLE 4

| | | | Solid | | | | | | | | | | Comparative | | | | |
|---|---|---|---|---|---|---|---|---|---|---|---|---|---|---|---|---|---|
| | Structural | | content | Examples | | | | | | | | | Examples | | | | |
| Ingredient | formula | Details | (%) | 1 | 2 | 3 | 4 | 5 | 6 | 7 | 8 | 9 | 1 | 2 | 3 | 4 | 5 |
| Flame | (I) + (IV) | Allylamine- | 20 | 5 | | | | | | | | | | | | | |
| retardant | | maleic acid | | | | | | | | | | | | | | | |
| aid | | copolymer | | | | | | | | | | | | | | | |
| (amphoteric | (II) + (IV) | Diallylamine | 40 | | 2.5 | | | | | | | | | | | | |
| polymer | | hydro- | | | | | | | | | | | | | | | |
| compound) | | chloride- | | | | | | | | | | | | | | | |
| | | maleic acid | | | | | | | | | | | | | | | |
| | | copolymer | | | | | | | | | | | | | | | |
| | (II) + (IV) | Methyl | 20 | | | 5 | | | | | | | | | | | |
| | | diallyiamine- | | | | | | | | | | | | | | | |
| | | maleic acid | | | | | | | | | | | | | | | |
| | | copolymer | | | | | | | | | | | | | | | |
| | (III) + (IV) | Diallyl- | 30 | | | | 3.3 | 3.3 | 3.3 | 3.3 | 1 | 6.7 | | | | | 20 |
| | | dimethyl- | | | | | | | | | | | | | | | |
| | | ammonium | | | | | | | | | | | | | | | |
| | | chloride- | | | | | | | | | | | | | | | |
| | | maleic acid | | | | | | | | | | | | | | | |
| | | copolymer | | | | | | | | | | | | | | | |
| | | (Molecular | | | | | | | | | | | | | | | |
| | | weight | | | | | | | | | | | | | | | |
| | | 25000) | | | | | | | | | | | | | | | |
| Flame | (A) | Guanidine | 50 | 10 | 10 | 10 | 10 | | | | 11.4 | 8 | 12 | | | | |
| retardant | | phosphate | | | | | | | | | | | | | | | |
| component 1 | | | | | | | | | | | | | | | | | |
| Flame | (A) | Phoslex | 50 | | | | | 10 | | | | | | 12 | | | |
| retardant | | A-1 + | | | | | | | | | | | | | | | |
| component 2 | | guanidine | | | | | | | | | | | | | | | |
| | | carbonate | | | | | | | | | | | | | | | |
| Flame | (A) | Phoslex | 50 | | | | | | 10 | | | | | | 12 | | |
| retardant | | A-2 + | | | | | | | | | | | | | | | |
| component 3 | | guanidine | | | | | | | | | | | | | | | |
| | | carbonate | | | | | | | | | | | | | | | |
| Flame | (A) | Phoslex | 50 | | | | | | | 10 | | | | | | 12 | |
| retardant | | A-4 + | | | | | | | | | | | | | | | |
| component 4 | | guanidine | | | | | | | | | | | | | | | |
| | | carbonate | | | | | | | | | | | | | | | |
| Finishing | — | SUN- | — | 1.5 | 1.5 | 1.5 | 1.5 | 1.5 | 1.5 | 1.5 | 1.5 | 1.5 | 1.5 | 1.5 | 1.5 | 1.5 | 1.5 |
| agent | | MARINA | | | | | | | | | | | | | | | |
| | | TS-155GT | | | | | | | | | | | | | | | |

| | | | | | | | | | | | | | | | |
|---|---|---|---|---|---|---|---|---|---|---|---|---|---|---|---|
| Mass ratio of amphoteric | — | 2/10 | 2/10 | 2/10 | 2/10 | 2/10 | 2/10 | 2/10 | 0.5/10 | 5/10 | — | — | — | — | — |
| polymer compound/ | | | | | | | | | | | | | | | |
| flame retardant component | | | | | | | | | | | | | | | |

| | | | | | | | | | | | | | | | |
|---|---|---|---|---|---|---|---|---|---|---|---|---|---|---|---|
| Properties | Flame retardance | NB | NB | NB | NB | NB | SE | SE | NB | NB | NB | SE | B | B | B |
| | Water spotting prevention | P | P | P | P | P | P | P | P | P | F | F | F | F | F |
| | Calcium chloride (CaCl₂) | P | P | P | P | P | P | P | P | P | F | P | P | P | P |
| | reactivity | | | | | | | | | | | | | | |
| | Fastness | 4 | 4 | 4 | 4 | 4 | 4 | 3-4 | 4 | 4 | 4 | 4 | 2 | 1 | 4 |

With reference to Table 4, flame retardances for Comparative Examples 1 and 2 were evaluated as good, but since the flame retardant aid according to an embodiment of the present invention was not used, water spotting could not be suppressed, and in particular, in Comparative Example 1, the generation of a white precipitate which could be a cause of water spotting was seen in the reaction with calcium chloride. Additionally, in the Comparative Examples 3 and 4, since the flame retardant aid according to an embodiment of the present invention was not used, sufficient improvement in both flame retardance and water spotting prevention was not seen, and furthermore, the evaluation of fastness was low. Since Comparative Example 5 did not comprise a flame retardant component as a main material, sufficient improvement in both flame retardance and water spotting prevention was not seen.

In contrast, in Examples 1 to 9, in which a flame retardant aid according to an embodiment of the present invention was used in conjunction with a flame retardant component, all Examples achieved good flame retardance while completely suppressing water spotting, and demonstrating good evaluation of calcium chloride reactivity and fastness as well. In particular, comparing Examples 5 to 7 with Comparative Examples 2 to 4, which used the same flame retardant component, it can be seen that flame retardance was improved by using the flame retardant aid according to an embodiment of the present invention relative to using the flame retardant component alone.

### INDUSTRIAL APPLICABILITY

By treating a polyester fiber fabric using a flame retardant aid necessarily comprising an amphoteric polymer compound having at least one of a specific cationic unit such as allylamine and an anionic unit such as maleic acid in conjunction with a flame retardant component, a vehicle interior material demonstrating good flame retardance with little or no reduction in fastness while preventing or remarkably suppressing water spotting due to hot water or aqueous calcium chloride solutions can be obtained. Additionally, when applying the flame retardant aid and a flame retarding agent composition comprising the same to a polyester fiber fabric, it is possible to use a convenient method of applying to the polyester fiber fabric by a treatment such as a padding process or a spraying process and then drying, and therefore to perform flame retarding of vehicle interior materials in a way that considers streamlining of the process and the environment.

1. A flame retardant aid comprising an amphoteric polymer compound having at least one of cationic unit selected from the group consisting of allylamine-based units expressed by formulas (I), (II) and (III): 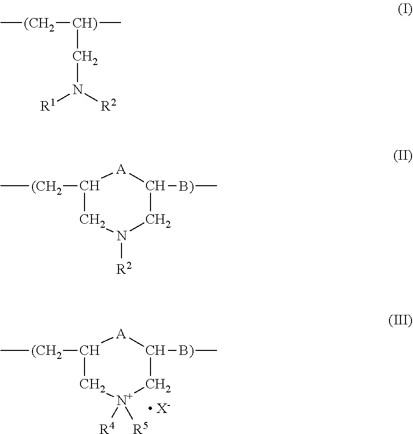
wherein R¹ and R² are each independently a hydrogen atom, a methyl group, an ethyl group, or a cyclohexyl group, R³ is a hydrogen atom, a methyl group, an ethyl group, or a benzyl group, R⁴ and R⁵ are each independently a hydrogen atom, a methyl group, an ethyl group, or a benzyl group, A and B can be direct bonds or CH₂ provided that when A is a direct bond, B is CH₂, and when A is CH₂, B is a direct bond, and X⁻ is an anion, and inorganic acid salts and organic acid salts thereof; and
an anionic unit expressed by formula (IV): 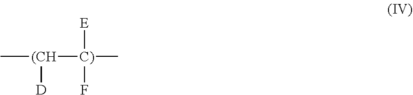
wherein D is H or COOY, E is R⁶ or COOY, and F is H, COOY, or CH₂COOY provided that when D is H, E is COOY and F is COOY or CH₂COOY and when D is COOY, E is R⁶ and F is COOY or E is COOY and F is H, R⁶ is a hydrogen atom or a methyl group, and Y is each independently selected from the group consisting of a hydrogen atom, Na, K, NH₄, ½Ca, ½Mg, ½Fe, ⅓Al, and ⅓Fe.

2. A flame retarding agent composition comprising a flame retardant component and the flame retardant aid according to claim 1.

3. The flame retarding agent composition according to claim 2, wherein the flame retardant component comprises at least one selected from the group consisting of phosphoric acid, an acidic phosphate ester expressed by formula (A):
(RO)ₓ—P(═O)—(OH)₃₋ₓ (A)
wherein R is a substituted or unsubstituted, linear, branched, or cyclic alkyl group having 1 to 10 carbon atoms, a substituted or unsubstituted, linear, branched, or cyclic alkenyl group having 2 to 10 carbon atoms, or a substituted or unsubstituted aryl group having 6 to 10 carbon atoms, and x is 1 or 2, wherein when x is 2, two R groups can be the same or different, and the salts thereof.

4. The flame retarding agent composition according to claim 2, wherein the mass ratio of the amphoteric polymer compound and the flame retardant component is 0.5:10 to 5:10.

5. A method of producing a flame-retardant fiber fabric comprising treating a polyester fiber fabric with a flame retardant component and the flame retardant aid according to claim 1, and drying the polyester fiber fabric.
